(19) United States
(12) Patent Application Publication
(10) Pub. No.: US 2015/0137593 A1
(43) Pub. Date: May 21, 2015

(54) VOLTAGE CONTROL IN AN ELECTRIC VEHICLE

(71) Applicant: Ford Global Technologies, LLC, Dearborn, MI (US)

(72) Inventors: Daniel Richard Luedtke, Beverly Hills, MI (US); Fazal Urrahman Syed, Canton, MI (US)

(73) Assignee: Ford Global Technologies, LLC, Dearborn, MI (US)

(21) Appl. No.: 14/085,920

(22) Filed: Nov. 21, 2013

(51) Int. Cl. B60L 11/18

(52) U.S. Cl. CPC B60L 11/1803
USPC 307/10.1

(57) ABSTRACT

An example voltage control method for a powertrain of a hybrid vehicle includes controlling a power supply system to vary a voltage limit based on temperature.

### BACKGROUND

This disclosure relates to controlling a power supply system of an electric vehicle and, more particularly, to controlling the power supply system to vary a voltage based on temperature.

Generally, electric vehicles differ from conventional motor vehicles because electric vehicles are selectively driven using one or more battery-powered electric machines. Conventional motor vehicles, by contrast, rely exclusively on an internal combustion engine to drive the vehicle. Electric vehicles may use electric machines instead of, or in addition to, the internal combustion engine.

Example electric vehicles include hybrid electric vehicles (HEVs), plug-in hybrid electric vehicles (PHEVs), and battery electric vehicles (BEVs). A powertrain of an electric vehicle is typically equipped with a battery that stores electrical power for powering the electric machine. The battery may be charged prior to use. The battery may be recharged during a drive by regeneration braking or an internal combustion engine.

The powertrain of an electric vehicle can include various switching devices, such as insulated gate bipolar transistors. The switching devices are typically sized based on a worst case stack-up of voltage across the switching devices. The cost and complexity of the switching devices increases as the voltage rating required by the power switching devices increases.

### SUMMARY

A voltage control method for a powertrain of electric vehicle according to an exemplary aspect of the present disclosure includes, among other things, controlling a power supply system to vary a voltage limit based on temperature.

In a further non-limiting embodiment of the foregoing method, the voltage limit comprises a limit of a maximum bus voltage.

In a further non-limiting embodiment of any of the foregoing methods, the voltage limit is a function of temperature.

In a further non-limiting embodiment of any of the foregoing methods, the function is a linear function.

In a further non-limiting embodiment of any of the foregoing methods, the method includes controlling power supply system to lower the voltage limit at low temperatures and to raise the voltage limit at high temperatures.

In a further non-limiting embodiment of any of the foregoing methods, the power supply system comprises a variable voltage controller.

In a further non-limiting embodiment of any of the foregoing methods, the voltage limit comprises a voltage limit through a switching device.

In a further non-limiting embodiment of any of the foregoing methods, the switching device comprises an insulated-gate bipolar transistor.

In a further non-limiting embodiment of any of the foregoing methods, the temperature comprises an ambient temperature.

A voltage control method for an electric vehicle according to an exemplary aspect of the present disclosure includes, among other things, adjusting a maximum bus voltage within a power supply system of an electric vehicle. The adjusting is in response to temperature.

In a further non-limiting embodiment of the foregoing voltage control method, the adjusting comprises limiting the maximum bus voltage as a function of temperature.

In a further non-limiting embodiment of any of the foregoing voltage control methods, the adjusting comprises lowering the maximum bus voltage in response to a low temperature and increasing the maximum bus voltage in response to a high temperature.

In a further non-limiting embodiment of any of the foregoing voltage control methods, the power supply system comprises a variable voltage controller.

In a further non-limiting embodiment of any of the foregoing voltage control methods, the adjusting of the maximum bus voltage adjusts a voltage through a switching device.

In a further non-limiting embodiment of any of the foregoing voltage control methods, the switching device comprises an insulated-gate bipolar transistor.

A voltage control system for an electric vehicle powertrain according to an exemplary aspect of the present disclosure includes, among other things, a power control system configured to vary a voltage limit in response to a temperature.

In a further non-limiting embodiment of the foregoing voltage control system, the system includes a sensor to measure the temperature.

In a further non-limiting embodiment of any of the foregoing voltage control systems, the system includes a bus, the voltage limit comprising a maximum voltage across the bus.

In a further non-limiting embodiment of any of the foregoing voltage control systems, the system includes a switching device, the voltage limit comprising a voltage limit through the switching device.

In a further non-limiting embodiment of any of the foregoing voltage control systems, the power control system is configured to vary the voltage limit as a function of the temperature.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a powertrain of an example electric vehicle.

FIG. 2 illustrates a schematic view of a power control system of the powertrain of FIG. 1.

FIG. 3 shows a plot of max voltage varied by the power control system of FIG. 2 based on temperature.

FIG. 4 shows an example voltage rating margin for switching devices of the FIG. 2 power supply system utilizing the max voltage based on temperature of FIG. 3.

### DETAILED DESCRIPTION

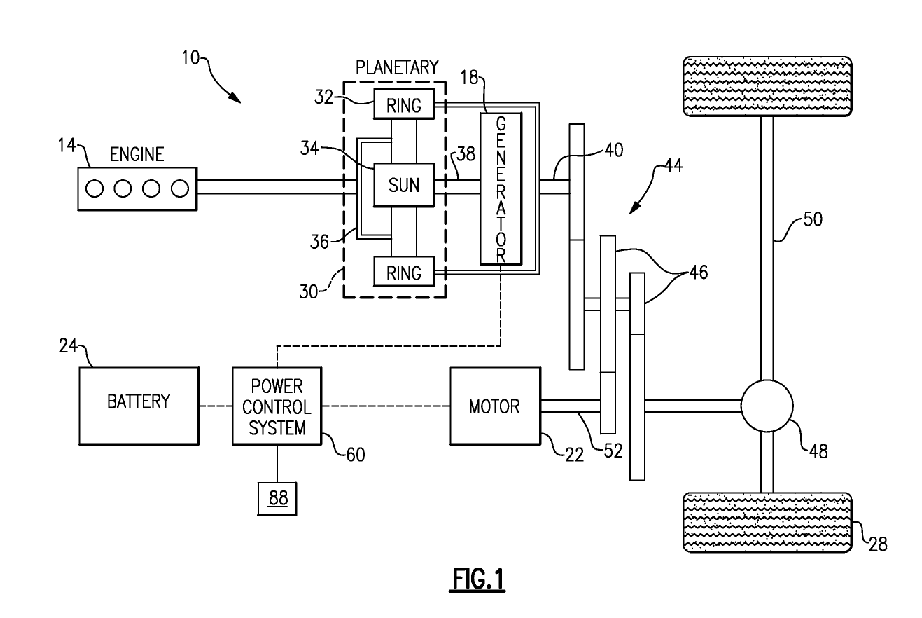

FIG. 1 schematically illustrates a powertrain 10 for an electric vehicle. Although depicted as a hybrid electric vehicle (HEV), it should be understood that the concepts described herein are not limited to HEVs and could extend to other electrified vehicles, including, but not limited to, plug-in hybrid electric vehicles (PHEVs) and battery electric vehicles (BEVs).

In one embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery 24. In this example, the second drive system is considered an electric drive system of the powertrain 10. The first and second drive systems generate torque to drive one or more sets of vehicle drive wheels 28 of the electric vehicle.

The engine 14, which is an internal combustion engine in this example, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery 24.

The battery 24 is an example type of electric vehicle battery assembly. The battery 24 may have the form of a high voltage battery that is capable of outputting electrical power to operate the motor 22 and the generator 18. Other types of energy storage devices and/or output devices can also be used with the electric vehicle having the powertrain 10.

The example powertrain 10 includes a power control system 60 that, among other things, converts and controls power to and from the battery 24. The power control system 60 could convert and control power in other areas of the powertrain 10 in other examples.

The power control system 60 modifies the power from the battery 24 for use by the motor 22. The power control system 60 modifies power generated by the generator 18 for storage within the battery 24. The power control system 60, for example, may convert DC to AC power, AC to DC power, limit or boost voltages, etc.

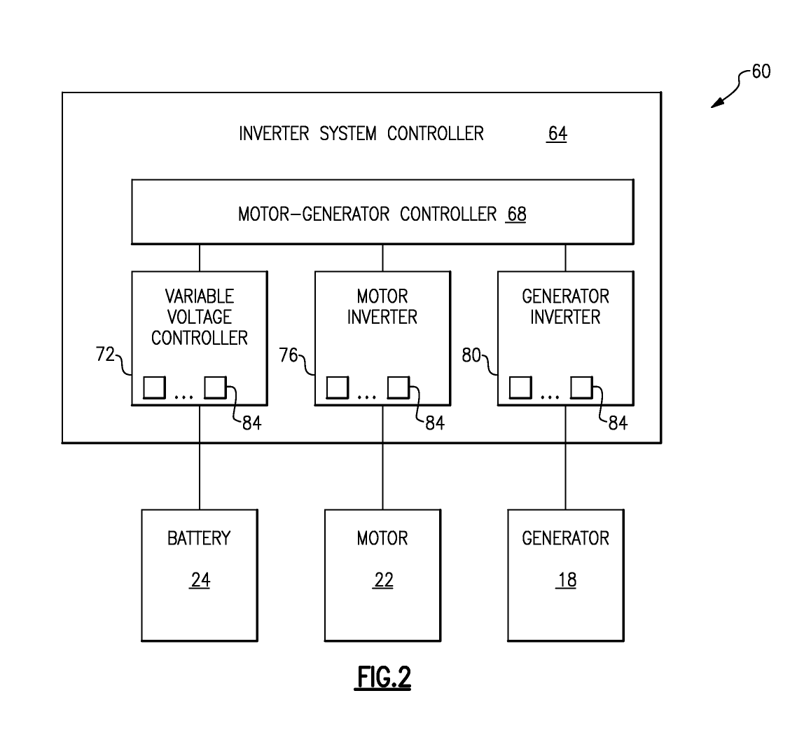

Referring now to FIG. 2 with continuing reference to FIG. 1, the example power control system 60 includes an inverter system controller 64 having a motor generator controller 68, a variable voltage controller 72, a motor inverter 76, and a generator inverter 80. The motor generator controller 68 is operatively connected to the variable voltage controller 72, the motor inverter 76, and the generator inverter 80. The motor inverter 76 is operably coupled to the motor 22. The generator inverter 80 is operably coupled to the generator 18.

The example variable voltage controller 72 limits or boosts voltage to and from the battery 24. In one example, the variable voltage controller 72 receives power at 250 to 280 volts from the battery 24. The variable voltage controller 72 boosts this power from the battery 24 to 400 volts. The power is then communicated at 400 volts from the variable voltage controller 72 to the motor 22. The motor operates more efficiently at higher speeds when receiving power at higher voltages.

The example motor inverter 76 changes DC power from the battery to AC power for the motor 22.

The example generator inverter 80 changes AC power from the generator to DC power for the battery 24.

The variable voltage controller 72, the motor inverter 76, and the generator inverter 80, in this example, each include more than one switching device 84. Other areas of the power control system 60 may include additional switching devices. Switching devices could also be located in other areas of the powertrain 10.

The switching devices 84 control flow of power between the various devices of the power control system 60 and other portions of the powertrain 10. Generally, the switching devices 84 open to prevent power flow and close to permit power flow. Insulated gate bipolar transistors (IGBT_{S}) are an example type of switching device 84 used within the powertrain 10.

The voltage blocking capability of switching devices 84 is lowest at cold temperatures. The voltage blocking capability increases significantly as temperatures increase. The switching devices 84 are generally sized to selectively block voltages at all operating temperatures of the powertrain 10.

The example power control system 60 is operably coupled to a temperature sensor 88. The power control system 60 receives temperature information from the sensor 88 and limits voltages based on the temperature.

The battery 24 is electrically connected to a bus that distributes power to and from the battery 24. In this example, the power control system 60 adjusts a maximum voltage of the bus to be lower at relatively low temperatures. The power control system 60 then adjusts the maximum voltage of the bus to be higher at relatively high temperatures.

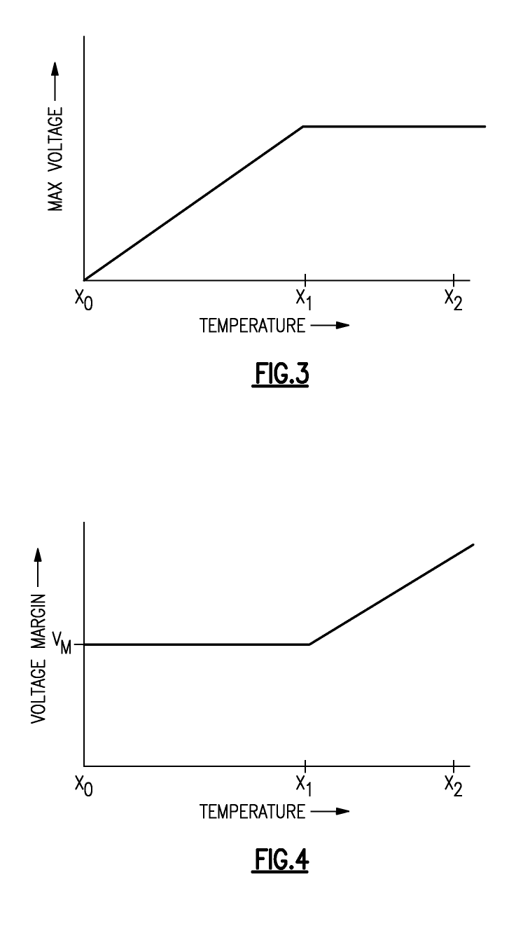

Referring to FIG. 3 with continuing reference to FIGS. 1 and 2, the maximum voltage is increased gradually from across the temperature range X₀ to X₁. The adjusting of the max voltage is a function of the temperature across the temperature range X₀ to X₁. In this example, the function is a linear function. As shown, if the temperature is in the range X₁ to X₂, the max voltage is kept consistent.

The power control system 60 is configured to establish a voltage limit or a maximum voltage for various temperature measurements from the temperature sensor 88. In one example, the variable voltage controller 72 utilizes a pulse width modulated converter to adjust the maximum voltage or to change the output voltage from the battery 24 to a level that can be accommodated by the switching devices 84. A person having skill in this art would understand how to utilize the power control system 60 to adjust a max voltage.

Notably, limiting the max voltage as a function of temperature enables a designer to select switching devices 84 that are less complex, less expensive, and have a lower voltage margin. FIG. 4 illustrates that the voltage margin is maintained above level Vₘ when the temperature is in the range X₀ to X₁.

Features of the disclosed examples include controlling a voltage that is communicated through switching devices to permit smaller switching devices to be used.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A voltage control method for a powertrain of electric vehicle, comprising:
controlling a power supply system to vary a voltage limit based on temperature.

2. The method of claim 1, wherein the voltage limit comprises a limit of a maximum bus voltage.

3. The method of claim 1, wherein the voltage limit is a function of temperature.

4. The method of claim 3, wherein the function is a linear function.

5. The method of claim 1, including controlling power supply system to lower the voltage limit at low temperatures and raise the voltage limit at high temperatures.

6. The method of claim 1, wherein the power supply system comprises a variable voltage controller.

7. The method of claim 1, wherein the voltage limit comprises a voltage limit through a switching device.

8. The method of claim 7, wherein the switching device comprises an insulated-gate bipolar transistor.

9. The method of claim 1, wherein the temperature comprises an ambient temperature.

10. A voltage control method for an electric vehicle, comprising:
adjusting a maximum bus voltage within a power supply system of an electric vehicle, the adjusting in response to temperature.

11. The method of claim 10, wherein the adjusting comprises limiting the maximum bus voltage as a function of temperature.

12. The method of claim 10, wherein the adjusting comprises lowering the maximum bus voltage in response to a low temperature and increasing the maximum bus voltage in response to a high temperature.

13. The method of claim 10, wherein the power supply system comprises a variable voltage controller.

14. The method of claim 10, wherein adjusting of the maximum bus voltage adjusts a voltage through a switching device.

15. The method of claim 14, wherein the switching device comprises an insulated-gate bipolar transistor.

16. A voltage control system for an electric vehicle powertrain, comprising:
a power control system configured to vary a voltage limit in response to a temperature.

17. The system of claim 16, including a sensor to measure the temperature.

18. The system of claim 16, including a bus, the voltage limit comprising a maximum voltage across the bus.

19. The system of claim 16, including a switching device, the voltage limit comprising a voltage limit through the switching device.

20. The system of claim 16, wherein the power control system is configured to vary the voltage limit as a function of the temperature.
